(19) United States
(12) Patent Application Publication
(10) Pub. No.: US 2011/0222368 A1
(43) Pub. Date: Sep. 15, 2011

(54) Detecting Seismic Data in a Wellbore

(75) Inventor: Don L. Fussell, Cypress, TX (US)

(73) Assignee: VCable, LLC, Houston, TX (US)

(21) Appl. No.: 12/720,916

(22) Filed: Mar. 10, 2010

(51) Int. Cl. G01V 1/40

(52) U.S. Cl. 367/25

(57) ABSTRACT

In one general embodiment, a seismic tool system includes a cable adapted to be deployed within a borehole; and one or more seismic tools suspendable from the cable in the borehole. At least one of the seismic tools includes at least one seismic sensor enclosed within a housing; one or more rollers attached to the housing and adapted to engage the borehole; and a bow spring attached to the housing and including one or more rollers adapted to engage the borehole. The one or more of the rollers are in acoustic communication with the seismic sensor.

### TECHNICAL BACKGROUND

This disclosure relates to detecting seismic data in a wellbore and, more particularly, to detecting seismic data in a wellbore by one or more seismic tools lowered into a wellbore.

### BACKGROUND

In a variety of situations, principally in oil and gas exploration, but also in environmental and civil engineering, there may be advantages to obtaining seismic data from a subterranean zone (e.g., a geological formation below the surface of the earth) by placing one or more seismic detectors in a wellbore drilled to a wide range of depths. Typically, such a seismic detector, often called a “sonde” or alternatively a “seismic tool,” is suspended from a cable and lowered into a borehole to a depth determined to be appropriate for the acquisition of seismic data relevant to the target area (i.e., the subterranean zone).

The seismic tools may be either digital or analog in design. Typically, a digital tool will include an analog to digital converter for the seismic signals as well as other circuitry to enable transmission of the acquired data to the surface. An analog tool, in contrast, may not include such circuitry, although it may include some form of active amplification to enhance signal levels. Further, there are typically two methods for recording seismic data in boreholes: active and passive. In active seismic recording, an energy source may be used to generate waves that travel through the subterranean zone and are recorded by one or more seismic sensors installed in the seismic tools. Such sources include explosives placed below ground level in drilled holes, large truck mounted devices called “vibrators,” or a variety of other methods of introducing energy into the subsurface. In passive seismic data recording, a signal received by the seismic tool may be generated by movements within the earth's subsurface, often referred to as “micro-quakes,” and passive seismic signals often called “micro-seismic.” Signal levels of these events tend to be much lower in amplitude than those generated by active seismic methods. Because of this lower signal level, effective coupling of the seismic tools to the borehole wall may be important.

A variety of methods may be used to couple the seismic tool to the borehole wall. For example, levers that are mechanically, electro-mechanically, or hydraulically actuated may be used to push the tool firmly against the borehole wall. Bow springs may be used for the same purpose but may not be actuated. Instead, such bow springs maintain a constant pressure against the wall as the tools are deployed and retrieved. There are several disadvantages to each of the above described methods. For instance, the various types of lever mechanisms are usually expensive and are all subject to various types of failures. These failures can cause the loss of data from one or more seismic tools and, in the worst case scenario, can fail to retract after actuation and result in the seismic tool becoming stuck in the borehole.

While the bow spring type devices may be designed and manufactured to provide excellent coupling, the higher the coupling force, the more difficult it may be to lower and raise the seismic tools hung on the cable. Additionally, the more levels of seismic tools installed on the cable, the greater force required to deploy and retrieved the seismic tools, because each of the individual tools must have its own individual bow spring attached. The friction of one or more bow springs against the borehole wall must be overcome in both deployment and retrieval. As a typical example, a borehole cable sensor array with forty levels must have forty bow springs, each in contact with the borehole wall and each applying the same pressure as every other bow spring in coupling the seismic tools to the wall. The friction generated by the forty bow springs must be overcome in lowering and raising the cable without damage. High clamping pressures of the bow springs to the borehole wall (e.g., those above forty to fifty pounds) may become problematic as the number of levels of seismic tools on a cable increases.

### SUMMARY

In one general embodiment, a seismic tool system includes a cable adapted to be deployed within a borehole; and one or more seismic tools suspendable from the cable in the borehole. At least one of the seismic tools includes at least one seismic sensor enclosed within a housing; one or more rollers attached to the housing and adapted to engage the borehole; and a bow spring attached to the housing and including one or more rollers adapted to engage the borehole. The one or more of the rollers are in acoustic communication with the seismic sensor.

In another general embodiment, a wellbore tool includes a housing enclosing one or more seismic sensors; one or more wheels attached to the housing; and one or more rollers coupled to the housing through a bow spring attached to the housing. The bow spring is adapted to apply a force substantially orthogonal to a longitudinal axis of the housing through the one or more rollers and one or more wheels.

In one or more aspects of one or more general embodiments, a longitudinal centerline of the housing may be offset from a centerline of the borehole.

In one or more aspects of one or more general embodiments, one or more rollers attached to the housing may be aligned with the longitudinal centerline of the housing.

In one or more aspects of one or more general embodiments, the one or more rollers attached to the housing may be wheels.

In one or more aspects of one or more general embodiments, the wheels may be radially disposed less than approximately 180 degrees apart around a circumference of the housing.

In one or more aspects of one or more general embodiments, the seismic sensor may be one of a geophone or a hydrophone.

In one or more aspects of one or more general embodiments, the cable may be adapted to transmit one or more acoustic signals from the seismic sensor to a location on a terranean surface.

In one or more aspects of one or more general embodiments, the seismic tool may be adapted to apply a clamping pressure to the borehole through engagement of the one or more rollers with the borehole.

In one or more aspects of one or more general embodiments, the clamping pressure may be determined based at least in part on a diameter of the borehole.

In one or more aspects of one or more general embodiments, a radius of the bow spring may be determined based at least in part on the borehole diameter.

In one or more aspects of one or more general embodiments, the one or more wheels attached to the housing may include roller bearings rotatably aligned with the longitudinal axis of the housing.

In one or more aspects of one or more general embodiments, the one or more wheels may be radially disposed less than approximately 180 degrees apart around a circumference of the housing.

In one or more aspects of one or more general embodiments, the housing may be adapted to be coupled to a cable, the cable adapted to deploy the wellbore tool into a borehole.

In one or more aspects of one or more general embodiments, the force may include a clamping pressure, the clamping pressure sufficient to engage the tool with a surface of a borehole disposed in a subterranean zone.

In one or more aspects of one or more general embodiments, the longitudinal axis of the housing may be offset from a longitudinal centerline of the tool.

Various embodiments of a seismic tool in accordance with the present disclosure may include one or more of the following features. For example, the seismic tool may include a bow spring design that allows for high clamping pressures of the seismic tool to a borehole wall. The bow spring design may allow for better acoustic coupling of the seismic tool to a subterranean zone via the borehole wall. The seismic tool may also allow for low friction forces between the tool and the borehole wall, thereby allowing greater ease of deployment and retrieval of the seismic tool from the borehole to a terranean surface. As another example, the seismic tool may be installed in the borehole such that a longitudinal centerline of the tool is offset from a centerline of the borehole. Additionally, the seismic tool may be tailored for the application requirements and borehole diameter by adjusting a radius of the bow spring and the spring force of the bow spring. The seismic tool may also be designed for the application requirements and borehole diameter through adjustment of one or more rollers installed on the tool. As an additional example, the seismic tool may be capable of being deployed without the use of various installation and retrieval methods, such as, for example, attachment to a wireline, coiled tubing, sucker rods, or other method of forcing the seismic tool into the borehole to overcome friction created by the bow springs clamping force. For example, the seismic tool may be deployed into the borehole by utilizing a weight installed at the bottom of the cable to pull the cable, including the seismic tool, into the borehole.

Various embodiments of a seismic tool in accordance with the present disclosure may also include one or more of the following features. For example, the seismic tool may be deployed in deviated boreholes without being obstructed by a bend in the borehole. Further, the seismic tool may be configured for a specific borehole diameter or may be configured for a wide range of borehole diameters. For instance, the seismic tool may allow for a variety of bow springs with different radii to be installed on the tool to account for different borehole diameters. In addition, the seismic tool may be less complex, more reliable, and more economical than other borehole coupling methods used for seismic tools. As another example, the seismic tool may allow for a smaller and more economical cable to be utilized in deploying one or more of the tools into the borehole, because the cable may not be required to account for high clamping pressures between the tool and the borehole.

These general and specific aspects may be implemented using a device, system or method, or any combinations of devices, systems, or methods. The details of one or more implementations are set forth in the accompanying drawings and the description below. Other features, objects, and advantages will be apparent from the description and drawings, and from the claims.

### DESCRIPTION OF DRAWINGS

FIG. 1 illustrates a system for deploying one or more seismic tools into a borehole in order to detect seismic data from a subterranean zone in accordance with the present disclosure;

FIGS. 2A-B illustrate one embodiment of a seismic tool in accordance with the present disclosure; and

FIGS. 3A-B illustrate another embodiment of a seismic tool in accordance with the present disclosure.

### DETAILED DESCRIPTION

In some embodiments of a seismic tool in accordance with the present disclosure, one or more roller bearings may be secured to a housing of the tool. The tool may also include a bow spring attached to the housing and including one or more rollers (e.g., roller bearings, casters, bronzed bushings, spherical rollers, axled rollers or bearings, or other roller devices). The bow spring has a predetermined radius and spring force. As the seismic tool is deployed within a borehole, the spring force engages the rollers with a borehole wall. The seismic tool is offset with the borehole such that a longitudinal centerline of the housing is offset from a centerline of the borehole. In some embodiments, the rollers may allow for reduced friction contact between the seismic tool and the borehole wall such that repositioning and deployment of the seismic tool within the borehole may be made easier. For example, a force required to reposition and/or deploy the seismic tool may account for a weight of the tool and the reduced frictional force between the rollers and the tool. In some embodiments, one or more of the rollers secured to the tool may be wheels disposed around a circumference of the housing. A radius of one or more of the wheels may be substantially orthogonal to an annulus of the borehole when the tool is deployed in the borehole.

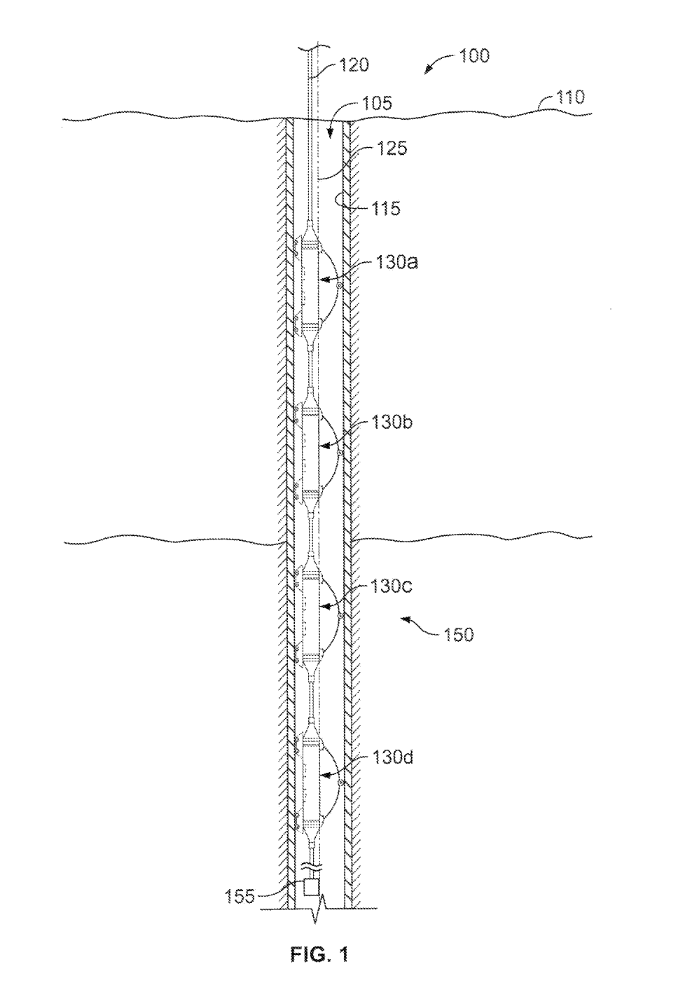

FIG. 1 illustrates a system 100 for deploying one or more seismic tools 130a-d into a borehole 105 in order to detect seismic data from a subterranean zone 150. The illustrated system 100 includes borehole 105 extending from a terranean surface 112 subterranean zone 150. The borehole 105 may be created by any appropriate method. For example, the borehole 105 may be a production wellbore capable of producing one or more hydrocarbons from subterranean zone 150 to the terranean surface 110. As another example, borehole 105 may be an injection wellbore providing a conduit for one or more fluids (e.g., fluids used to displace hydrocarbons located in subterranean zone 150) to be injected into the subterranean zone 150 (or other zones) from the terranean surface 110. Borehole 105 may also be created to allow access to one or more subterranean zones, such as subterranean zone 150, in order to collect, receive, or monitor seismic data from such zones. For example, the borehole 105 may be drilled to a predetermined depth located within subterranean zone 150 in order to deploy an array of seismic tools supported by a cable 120.

In the illustrated embodiment, a casing 115 is installed through at least a portion of the borehole 105. The casing 115 may be disposed from the terranean surface 110 through one or more subterranean zones including the subterranean zone 150. In some embodiments, the casing 115 may be a metallic conduit (e.g., a pipe or otherwise) providing a contactable surface with the subterranean zones. In some embodiments, the casing 115 may be a segmented casing with varying thickness is as it extends from the terranean in surface 110 through the subterranean zones, including subterranean zone 150. In some embodiments, the casing 115 may be secured into place by cementing or other techniques.

While borehole 105 is shown as a vertical borehole with a centerline 125, the present disclosure contemplates that any suitable borehole may be used to deploy seismic tools 130a-d on the cable 120 into the subterranean zones, including subterranean zone 150. For example, the borehole 105 may be a directional borehole that extends vertically from the terranean surface 110 into the subterranean zones and turns to a substantially horizontal direction. The directional borehole may include a radius coupling the vertical section and horizontal sections of the borehole. Borehole 105 may also be a multilateral borehole including several directional legs drilled from a single vertical wellbore. Borehole 105 may also include other types of boreholes not specifically described herein.

System 100 includes a number of seismic tools 130 deployed into the borehole 105 on cable 120. In some embodiments, the cable may be a metallic (or other material) rope that extends into the wellbore 105 and is attached to each of the seismic tools 130a-d. The cable 120, for example, may be a flexible metallic cable that can bend as required to be inserted into directional boreholes, multilateral boreholes, and other deviated boreholes. In some embodiments, the cable 120 may allow for data communication therethrough, such as digital data, analog data, and/or seismic or acoustic data from one or more of the seismic tools 130a-d. For example, one or more acoustic signals received at the seismic tools 130a-d from the subterranean zones, including subterranean zone 150, may be transmitted to the terranean surface 110 through the cable 120. Such data may be received from the cable 120 and transmitted to one or more remote locations including data processing equipment (not shown). As such, seismic data may be determined through the cable 120 from the seismic tools 130a-d deployed in borehole 105.

System 100 may also include a weight 155 installed on the cable 120 at a downhole end of the cable 120. Weight 155, for example, may be any appropriate object designed to pull (through gravitational force) the seismic tools 130a-d into the borehole 105. For example, the weight 155 may be heavier than the sum of the weights of the seismic tools 130a-d and a length of the cable 120 deployed in the borehole 105. Thus, upon release of the cable 120 including the seismic tools 130a-d into the borehole 105, the weight 155 may pull the tools 130a-d and cable 120 into the borehole 105. In some embodiments, the weight 155 may be designed to account for a reduced friction force between the tools 130a-d and the borehole 105.

As illustrated, four seismic tools 130a-d are shown deployed on the cable 120 into the borehole 105. In other embodiments, many more seismic tools 130 (or less seismic tools 130) may be deployed on the cable 120. The system 100 may include, for example, forty seismic tools 130 deployed on the cable 120, thereby providing forty levels of seismic data detection in one or more subterranean zones, including subterranean zone 150. In other examples, there may be eight to twelve seismic tools 130 deployed on the cable 120 at various locations within the borehole 105. Design considerations that may be taken into account in determining the number of seismic tools 130 deployed on the cable 120 may include a depth of a particular subterranean zone, such as subterranean zone 150, from which seismic data is desired, a thickness of the subterranean zone, a geological makeup of the subterranean zone, and other factors.

Seismic tools 130a-d may include one or more seismic receivers, or seismic sensors. For example, such sensors may be geophones, such as velocity sensors or accelerometers. Such sensors may also include hydrophones, such as pressure transducers. In some embodiments of system 100, some of the seismic tools 130a-d may include geophones while other seismic tools 130a-d may include hydrophones. In addition, one of more of the seismic tools 130a-d may be digital seismic tools, including an analog to digital converter as well as other circuitry to allow for acquired seismic data to be digitally transmitted to the surface 110. Alternatively, one or more of the seismic tools 130a-d may be analog tools, which may include active amplification to transmit receive seismic data to the surface 110.

In addition, each of the seismic tools 130a-d may be utilized in both active and passive seismic recording without departing from the scope of the present disclosure. For example, system 100 may be a part of an active seismic recording system such that explosives or surface located vibrators (not shown) may be utilized to introduce seismic energy into one or more subterranean zones adjacent the borehole 105, including subterranean zone 150. Alternatively, the system 100 may be a part of a passive seismic recording system such that seismic data is gathered by the seismic tools 130 through physical contact with the borehole 105 (through the casing 115). For example, as illustrated, each of the seismic tools 130a-d are in physical contact with the casing 115 of the borehole 105. As explained in more detail below, each of the seismic tools 130a-d may be in contact with the casing 115 through one or more rollers, a housing of the tool, or other component of the tool.

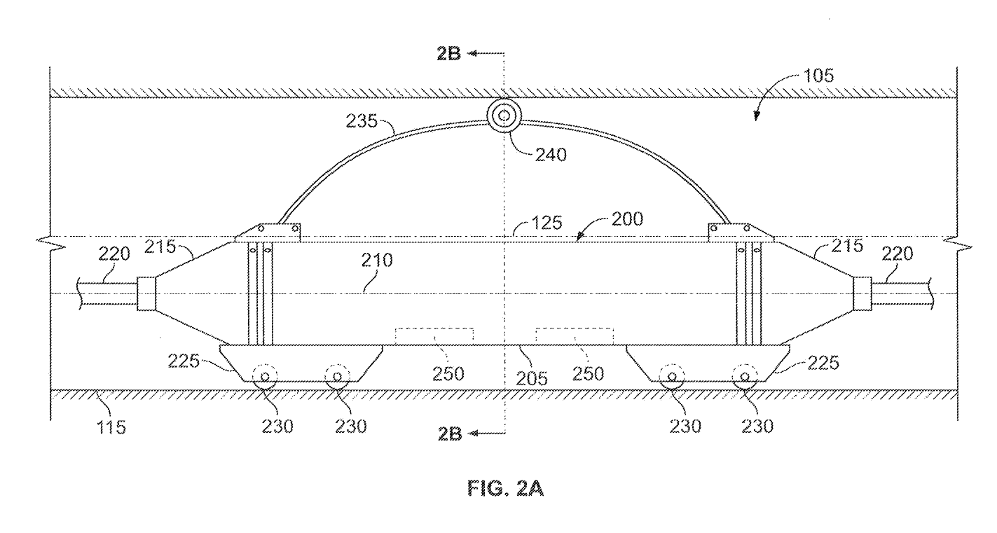

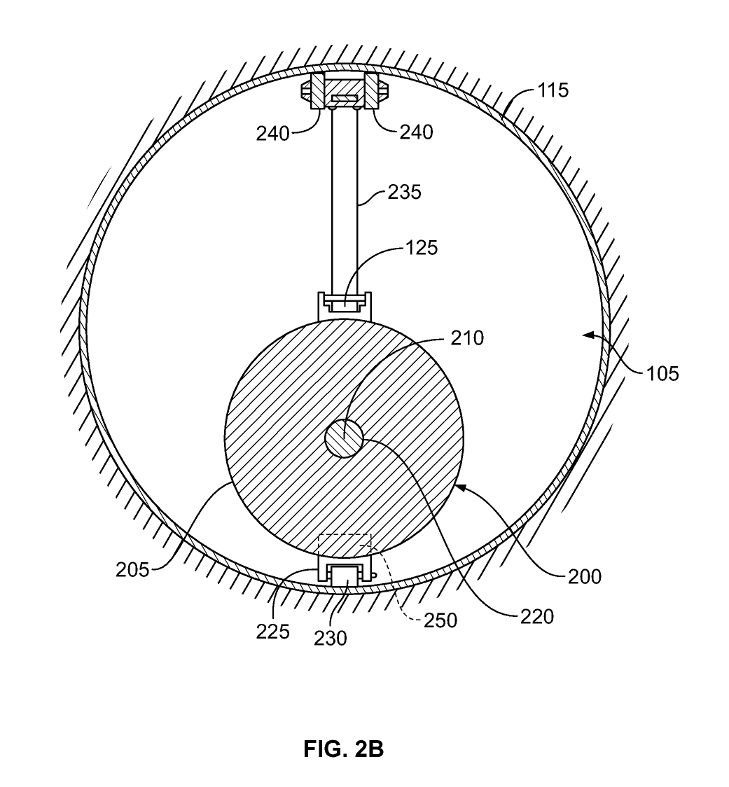

FIGS. 2A-B illustrate one embodiment of a seismic tool 200 that may be utilized in system 100 or other systems for detecting seismic data from a subterranean zone. In some embodiments, seismic tool 200 may be utilized as one or more of the seismic tools 130a-d shown in system 100. In addition, seismic tool 200 may be used in addition to seismic tools 130a-d shown in system 100.

Seismic tool 200 includes a housing 205 that encloses one or more seismic sensors 250. The housing 205, as illustrated, may be substantially cylindrical with a substantially circular cross-section and be made of a corrosion resistant material (e.g., stainless steel, Inconel, or other material, such as a hydrogen sulfide resistant material). The seismic sensors 250 may be geophones or hydrophones, or other type of sensor, such as velocity sensors, accelerometers, and/or pressure transducers. Although shown within the housing against an exterior surface of the housing 205, the sensors 250 may be deployed anywhere within the housing 205 such that the sensors 250 are in acoustic communication with the casing 115.

Attached to distal ends of the housing 205 are end caps 215 that allow for coupling of a cable 220 to the housing 205. The cable 220 may be substantially similar to the cable 120 shown in system 100 and may couple the seismic tool 200 to another seismic tool located uphole or downhole of the seismic tool 200 or, alternatively, another wellbore tool, such as the weight 155. Typically, the cable 220 allows for acoustic data communication from one or more of the sensors 250 to the terranean surface 110.

Seismic tool 200 includes one or more skates 225 attached to the housing 205 and/or a portion of the end caps 215. The skates 225 include one or more roller bearings 230 contacting the casing 115 and allowing for a reduced friction movement of the seismic tool 200 against the casing 115. In the illustrated embodiment, two skates 225 are shown, each including two roller bearings 230. Alternatively, more or less skates 225 may be attached to the seismic tool 200, each including more or less roller bearings 230. As illustrated more specifically in FIG. 2B, each of the roller bearings 230 may be substantially aligned with a centerline 210 of the housing 205.

Seismic tool 200 also includes a bow spring 235 attached to the housing 205 at two locations. The bow spring 235 also includes one or more roller bearings 240 attached thereto and in contact with the casing 115. In some embodiments, as shown in FIG. 2B, there may be two roller bearings 240 attached at an apex of the bow spring 235 and on either side of the spring 235. As illustrated, the roller bearings 240 are attached to the bow spring 235 parallel to the edges of the bow spring 235.

In some embodiments, the bow spring 235 may be designed to match a diameter of the borehole 105. For example, the seismic tool 200 may be adjustable to fit a variety of borehole diameters by changing the bow spring 235 to fit a particular diameter. For instance, as the borehole diameter increases, the bow spring 235 attached to the housing 205 may require a larger radius. As the borehole diameter decreases, however, the bow spring 235 may require a smaller diameter.

In addition, the bow spring 235 may have a predetermined clamping force (i.e., spring force directed away from the housing 205) that may be applied to be casing 115. The clamping force may allow for the seismic tool 200 to be substantially secured to the casing 115 so as to receive one or more acoustic, or seismic, signals from one or more subterranean zones.

Turning in particular to FIG. 2B, the seismic tool 200 is illustrated in the borehole 115 from an uphole perspective. As illustrated, the roller bearings 230 and 240 are illustrated in contact with the casing 115 thereby providing a seismic signal path from one or more subterranean zones to the sensors 250 enclosed within the housing 205. As illustrated in FIGS. 2A-B, the housing centerline 210 is offset from the borehole centerline 125. Therefore, the seismic tool 200 may be decentralized within the borehole 105.

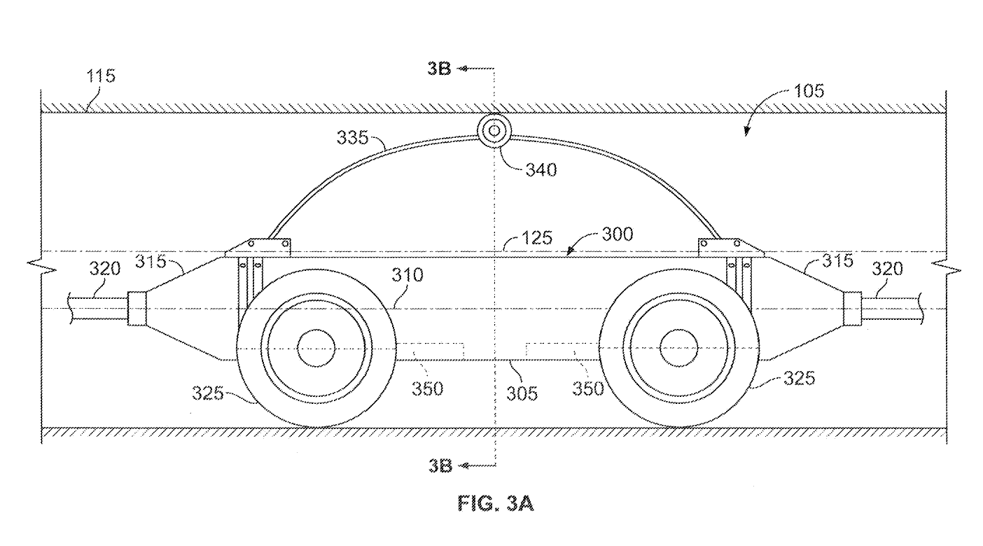

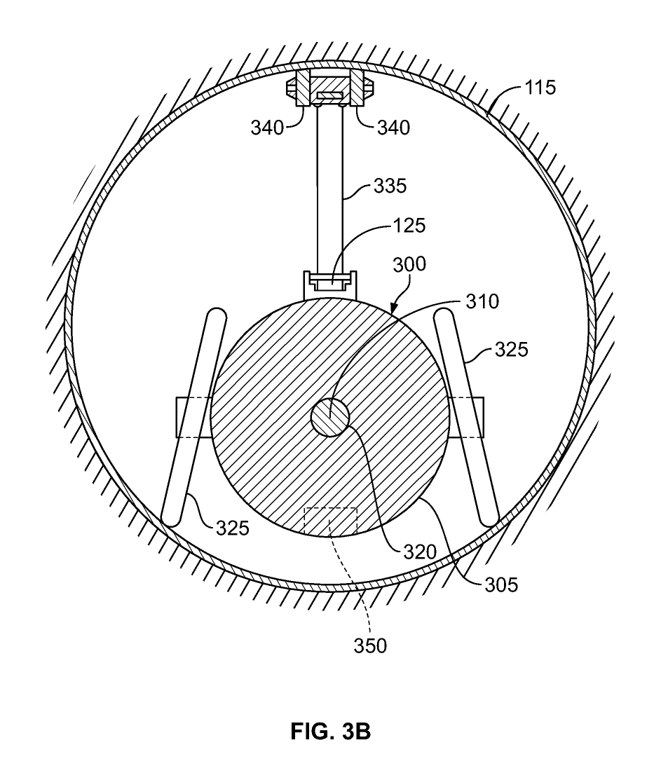

FIGS. 3A-B illustrate one embodiment of a seismic tool 300 that may be utilized in system 100 or other systems for detecting seismic data from a subterranean zone. In some embodiments, seismic tool 300 may be utilized as one or more of the seismic tools 130a-d shown in system 100. In addition, seismic tool 300 may be used in addition to seismic tools 130 shown in system 100.

Seismic tool 300 includes a housing 305 that encloses one or more seismic sensors 350. The housing 305, as illustrated, may be substantially cylindrical with a substantially circular cross-section and be made of a corrosion resistant material (e.g., stainless steel, Inconel, or other corrosion resistant material, such as for boreholes 105 that may contain hydrogen sulfide). The seismic sensors 350 may be geophones or hydrophones, or other type of sensors, such as velocity sensors, accelerometers, and/or pressure transducers. Although shown within the housing 305 on an exterior surface of the housing 305, the sensors 350 may be deployed anywhere within the housing 305 such that the sensors 350 are in acoustic communication with the casing 115.

Attached to distal ends of the housing 305 are end caps 315 that allow for coupling of a cable 320 to the housing 305. The cable 320 may be substantially similar to the cable 120 shown in system 100 and may couple the seismic tool 300 to another seismic tool located uphole or downhole of the seismic tool 300 or, alternatively, another wellbore tool, such as the weight 155. Typically, the cable 320 allows for acoustic data communication from one or more of the sensors 350 to the terranean surface 110.

Seismic tool 300 includes one or more wheels 325 attached to the housing 305. The wheels 325, as shown in FIG. 3B, may be coupled to opposed hemispheres of the housing 305 and in contact with the casing 115. For example, the wheels 325 may be offset by less than 180 degrees around a circumference of the housing 305. As illustrated, the wheels 325 are attached to the housing 305 near distal ends of the housing 305. Alternatively, the wheels 325 may be attached to the housing 305 at other locations. In addition, more or less wheels 325 may be utilized with the seismic tool 300. In some embodiments, each of the wheels 325 may provide for reduced friction contact with the casing 115, thereby allowing for adjustment, retrieval, and/or deployment of the tool 300 within the borehole 105. Further, in some embodiments, each wheel 325 may be attached to the housing 305 (or other portion of the tool 300) such that the wheel 325 is angled relative to the diameter of the borehole 105 when the tool 300 is inserted therein.

Seismic tool 300 also includes a bow spring 335 attached to the housing 305 at two locations. The bow spring 335 also includes one or more roller bearings 340 attached thereto and in contact with the casing 115. In some embodiments, as shown in FIG. 3B, there may be two roller bearings 340 attached at an apex of the bow spring 335 and on either side of the spring 335. As illustrated, the roller bearings 340 are attached to the bow spring 335 parallel to the edges of the bow spring 335. In some embodiments, the bow spring 335 may be designed to match a diameter of the borehole 105. In addition, the bow spring 335 may have a predetermined clamping force that may be applied to be casing 115. The clamping force may allow for the seismic tool 300 to be substantially secured to the casing 115 so as to receive one or more acoustic, or seismic, signals from one or more subterranean zones.

Turning in particular to FIG. 3B, the seismic tool 300 is illustrated in the borehole 115 from an uphole perspective. As illustrated, the roller bearings 330 and 340 are illustrated in contact with the casing 115 thereby providing a seismic signal path from one or more subterranean zones to the sensors 350 enclosed within the housing 305. As illustrated in FIG. 3A and 3B, the housing centerline 310 may be offset from the borehole centerline 125. Therefore, the seismic tool 300, like the tool 200, may be decentralized within the borehole 105.

One example operation of seismic tools 200 and/or 300 may be as follows. For example, each seismic tool may be coupled to a cable to be deployed within a borehole. In some cases, a number of tools may be deployed along a single cable in order to create an array of seismic tools to receive seismic and/or acoustic signals from multiple locations within one or more subterranean zones. One or more wheels and/or roller bearings coupled to the seismic tool may be engaged in contact with a casing (or other surface) of the borehole. One or more of the wheels and/or roller bearings may, therefore, provide for at least one portion of a physical path for seismic/acoustic signals to travel from one or more subterranean zones to one or more seismic sensors within the seismic tool. In addition, one or more roller bearings in contact with the casing may be coupled to a bow spring coupled to the housing of the seismic tool and exert a clamping force on the casing. The clamping force may secure the seismic tool to the casing of the borehole. While secured to the casing, the seismic tool may receive seismic signals from the one or more subterranean zones.

After receipt of the seismic signals, the seismic tool may be repositioned in the borehole adjacent another subterranean zone or retrieved from the borehole altogether. For example, if the tool is to be repositioned downhole, the cable deploying the seismic tool may be released such that a weight attached to the cable may pull the cable downhole. In some instances, the weight may be sized to account for the weight of the tools (e.g., forty pounds per tool) and cable plus any frictional force generated by the clamping pressure of the bow spring. If the tool is to be repositioned uphole or retrieved, an upward (i.e., uphole) tensile force may be applied to the cable to overcome the load of the weight, tools, and cable plus any frictional force generated by the clamping pressure of the bow spring.

A number of embodiments have been described. Nevertheless, it will be understood that various modifications may be made. For example, in some embodiments, a cable coupled to one or more seismic tools, such as the cable 120, may be an assembly of one or more electrical or optical conductors. In some aspects, each conductor may be insulated from other conductors in the assembly. In some embodiments, the conductors may be enclosed, such as, for example, in a thermoplastic (e.g., polyurethane, Teflon) or metallic (e.g., stainless steel) jacket. In some embodiments, alternatively, the cable may be a wireline, such as slickline or multistrand conductor. Accordingly, other embodiments are within the scope of the following claims.

1. A seismic tool system comprising:
a cable adapted to be deployed within a borehole; and
one or more seismic tools suspendable from the cable in the borehole, each of the seismic tools comprising:
at least one seismic sensor enclosed within a housing;
one or more rollers attached to the housing and adapted to engage the borehole;
a bow spring attached to the housing and including one or more rollers adapted to engage the borehole,
wherein one or more of the rollers are in acoustic communication with the seismic sensor, and
wherein a radius of the bow spring is determined based at least in part on a diameter of the borehole.

2. The system of claim 1, wherein a longitudinal centerline of the housing is offset from a centerline of the borehole.

3. The system of claim 2, wherein the one or more rollers attached to the housing are aligned with the longitudinal centerline of the housing.

4. The system of claim 1, wherein the one or more rollers attached to the housing comprise wheels.

5. The system of claim 4, wherein the wheels are radially disposed less than approximately 180 degrees apart around a circumference of the housing.

6. The system of claim 1, wherein the seismic sensor comprises one of a geophone or a hydrophone.

7. The system of claim 1, wherein the cable is adapted to transmit one or more acoustic signals from the seismic sensor to a location on a terranean surface.

8. The system of claim 1, wherein the seismic tool is adapted to apply a clamping pressure to the borehole through engagement of the one or more rollers with the borehole.

9. The system of claim 8, wherein the clamping pressure is determined based at least in part on the diameter of the borehole.

10. (canceled)

11. A wellbore tool comprising:
a housing enclosing one or more seismic sensors;
one or more wheels attached to the housing; and
one or more rollers coupled to the housing through a bow spring attached to the housing, the bow spring adapted to apply a force substantially orthogonal to a longitudinal axis of the housing through the one or more rollers and one or more wheels,
wherein a radius of the bow spring is determined based at least in part on a diameter of a borehole.

12. The wellbore tool of claim 11, wherein the one or more wheels attached to the housing comprise roller bearings rotatably aligned with the longitudinal axis of the housing.

13. The wellbore tool of claim 11, wherein the one or more wheels are radially disposed less than approximately 180 degrees apart around a circumference of the housing.

14. The wellbore tool of claim 11, wherein the seismic sensors comprise one or more geophones or hydrophones.

15. The wellbore tool of claim 11, wherein the housing is adapted to be coupled to a cable, the cable adapted to deploy the wellbore tool into a borehole.

16. The wellbore tool of claim 15, wherein the cable is adapted to transmit one or more acoustic signals from the seismic sensors to a location on a terranean surface.

17. The wellbore tool of claim 11, wherein the force comprises a clamping pressure, the clamping pressure sufficient to engage the tool with a surface of a borehole disposed in a subterranean zone.

18. The wellbore tool of claim 17, wherein the clamping pressure is determined based at least in part on a diameter of the borehole.

19. (canceled)

20. The wellbore tool of claim 11, wherein the longitudinal axis of the housing is offset from a longitudinal centerline of the tool.
